(19) United States
(12) Patent Application Publication
(10) Pub. No.: US 2007/0133867 A1
(43) Pub. Date: Jun. 14, 2007

(54) Apparatus and method of adaptively converting image in image display system

(75) Inventors: Dusik Park, Suwon-si (KR); Changyeong Kim, Yongin-si (KR); Seongdeok Lee, Suwon-si (KR); Wonhee Choe, Gyeongju-si (KR)

Correspondence Address: BUCHANAN, INGERSOLL & ROONEY PC, POST OFFICE BOX 1404, ALEXANDRIA, VA, 22313-1404, US

(73) Assignee: SAMSUNG ELECTRONICS., LTD., Suwon-si (KR)

(21) Appl. No.: 11/302,150

(22) Filed: Dec. 14, 2005

(51) Int. Cl. G06K 9/00

(52) U.S. Cl. 382/162

(57) ABSTRACT

Adaptive image conversion method and apparatus in an image display system are provided. The image conversion apparatus for adaptively converting an input image into an output image reflecting a user's preferred color comprises a color temperature estimation unit estimating a color temperature of the input image, a target color temperature calculation unit receiving the estimated color temperature and the user's preferred color temperature, and obtaining a target color temperature adaptively varying on the basis of the user's preferred color temperature according to the difference of the estimated color temperature and a preset reference color temperature, and a color temperature conversion unit obtaining a color temperature conversion coefficient from the estimated color temperature and the target color temperature and converting the input image into the output image based on the color temperature conversion coefficient.

### BACKGROUND OF THE INVENTION

1. Field of the Invention

The present invention relates to an apparatus and a method of adaptively converting an input image to be displayed on an image display system into an output image reflecting a user's preferred color temperature.

2. Description of the Related Art

In order to convert a color temperature into a user's preferred one, a TV or a monitor has commonly a control terminal capable of varying the quantity of hues, or red, green and blue (RGB) colors. By adjusting the control terminal for an arbitrary image or scene, a user could adjust a color temperature according to the user's preference. However, adjusting the control terminal by the user in moving pictures having a variety of scenes of digital contents when necessary causes much inconvenience.

Currently, a lot of research activities on software-based methods of estimating an illumination color or a color temperature of an image are being carried out. By using these methods of estimating a color temperature of an image, a color temperature conversion method of converting an input image into an image having a user's preferred color temperature can be considered. When a color temperature is converted, if an estimated color temperature of an input image is converted simply into a single color temperature preset by a user, the following problem can arise.

That is, by converting a color temperature into a preset single color temperature even when the color temperature of an input image is lower or higher than the user's preferred color temperature, characteristics of the input image can be lost. For example, input images having lower red-color-family color temperatures or higher blue-color-family color temperatures are mapped to an image having a single temperature such that the characteristics of the input images can be lost.

### SUMMARY OF THE INVENTION

The present invention provides an apparatus for adaptively converting an input image to be displayed on an image display system into an output image reflecting a user's preferred color temperature in which image conversion is performed by adaptively adjusting the amount of color temperature conversion on the basis of a user's preferred color temperature, according to the difference of an estimated color temperature of the input image and a reference color temperature, and a method thereof.

According to an aspect of the present invention, there is provided an image conversion apparatus for adaptively converting an input image into an output image reflecting a user's preferred color comprising: a color temperature estimation unit estimating a color temperature of the input image; a target color temperature calculation unit receiving the estimated color temperature and the user's preferred color temperature, and obtaining a target color temperature adaptively varying on the basis of the user's preferred color temperature according to the difference of the estimated color temperature and a preset reference color temperature; and a color temperature conversion unit obtaining a color temperature conversion coefficient from the estimated color temperature and the target color temperature and converting the input image into the output image based on the color temperature conversion coefficient.

According to another aspect of the present invention, there is provided an image conversion method for adaptively converting an input image into an output image reflecting a user's preferred color comprising: estimating a color temperature of the input image; receiving the estimated color temperature and the user's preferred color temperature, and obtaining a target color temperature adaptively varying on the basis of the user's preferred color temperature according to the difference of the estimated color temperature and a preset reference color temperature; and obtaining a color temperature conversion coefficient from the estimated color temperature and the target color temperature and converting the input image into the output image based on the color temperature conversion coefficient.

According to still another aspect of the present invention, there is provided a computer-readable recording medium having recorded thereon computer-readable programs for performing the above method.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 is a schematic block diagram of an embodiment of an adaptive image conversion apparatus according to the present invention;

FIG. 2 is a flowchart of an adaptive image conversion method applied to the adaptive image conversion apparatus shown in FIG. 1;

FIG. 3 shows graphs explaining examples of sources of illumination mainly used in our surroundings;

FIG. 4 is a conceptual diagram explaining an embodiment of color temperature conversion forms according to the present invention;

FIG. 5 is a more detailed diagram of FIG. 4;

FIG. 6 is a conceptual diagram explaining another embodiment of color temperature conversion forms according to the present invention;

FIG. 7 is a more detailed diagram of FIG. 6;

FIG. 8 is a conceptual diagram explaining a color temperature conversion form converting into one user's preferred color temperature;

FIG. 9 is a block diagram of another embodiment of an adaptive image conversion apparatus according to the present invention;

FIG. 10 is a flowchart showing an adaptive image conversion method applied to the adaptive image conversion apparatus of FIG. 9;

FIG. 11 is a conceptual diagram explaining still another embodiment of color temperature conversion forms enabling to provide a feeling of a predetermined color temperature according to the present invention;

FIG. 12 is a conceptual diagram explaining a linear mapping of the color temperature applied to the color temperature conversion form of FIG. 11;

FIG. 13 is a conceptual diagram explaining still another embodiment of a color temperature conversion forms converting a color temperature into a bluer or redder one on the basis of a reference color temperature according to the present invention;

FIG. 14 is a conceptual diagram explaining a linear mapping of the color temperature applied to the color temperature conversion form of FIG. 13;

FIG. 15 is a conceptual diagram explaining a nonlinear mapping of the color temperature applied to the color temperature conversion forms; and

FIG. 16 is a diagram showing another embodiment of a color temperature conversion form enabling to perform a different color temperature conversion in each segment of color temperatures of an input image according to the present invention.

### DETAILED DESCRIPTION OF THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

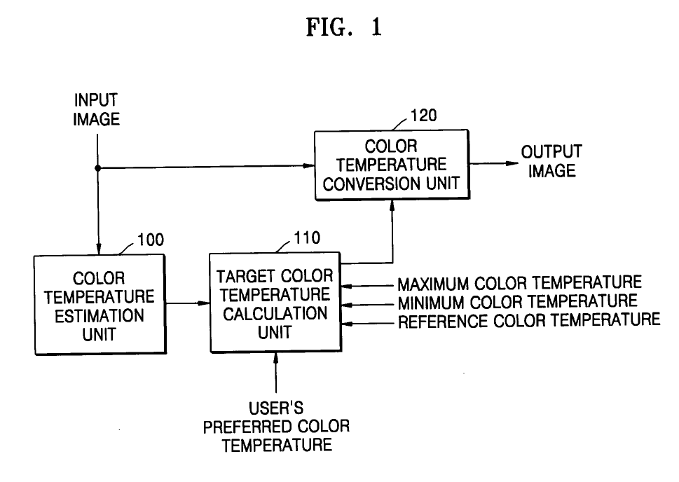

FIG. 1 is a schematic block diagram of an embodiment of an adaptive image conversion apparatus according to the present invention. The adaptive image conversion apparatus includes a color temperature estimation unit 100, a target color temperature calculation unit 110, and a color temperature conversion unit 120.

Referring to FIG. 1, the color temperature estimation unit 100 receives an input image to be displayed on an image display system such as a TV and a monitor, and estimates a color temperature of the input image.

Generally, colors in an image are expressed by tristimulus values such as RGB or Commission internationale de I'Eclairage (CIE) XYZ. A color Xₖ is mathematically expressed as the sum of products of the spectral reflectance S(λ) of an object surface, the spectrum E(λ) of an illuminant lighting the object, and the wavelength of the spectral characteristic rₖ(λ) of a sensor such as a camera, as shown in Equation 1. The illumination element in Equation 1 is a major element affecting the entire color tone of an image regardless of the type of an object:
Xₖ=ΣE(λ)S(λ)rₖ(λ)Δλ,k=1˜3(X,Y,Z or R,G,B) (1)

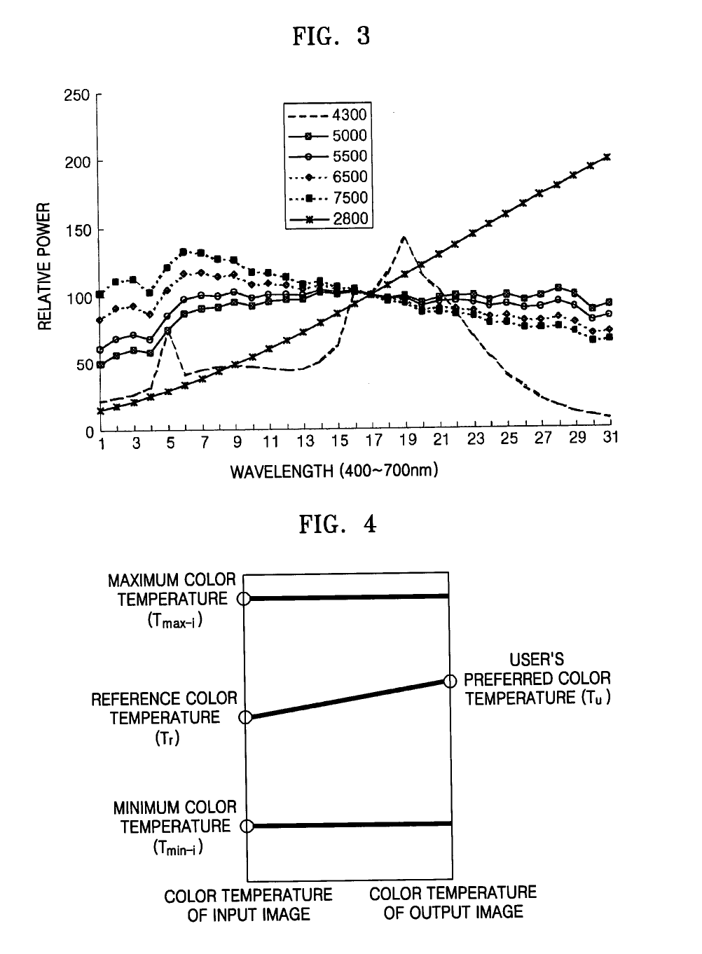

The color temperature of an image means the spectrum of the illuminant, that is, the color of the illuminant. In an image display apparatus such as a TV and a monitor, a light emitting device, such as a cathode ray tube (CRT) and a liquid crystal display (LCD), is also a major element affecting the color temperature in addition to the color of the illuminant in the image. FIG. 3 shows graphs explaining an incandescent lamp (color temperature, 28000K), a fluorescent lamp (4300K), and a variety of sun lights (5000K, 5500K, 6500K, and 7500K) as examples of sources of illumination mainly used in our surroundings. As a measure unit for the color temperature, absolute temperature K is used, and these values can be expressed in an RGB or CIE XYZ color space.

Color expression in an image is defined differently in many international standards such as the National Television System Committee (NTSC) and HDTV. The reason is that a color expression medium such as a color filter or phosphor, in a CRT and LCD, cannot comply with the protocols described in the standards. In addition, since CIE 1931 or 1964 standard observer is different from the visual characteristics of actual human beings, each of individuals watching TVs or computer monitors requires a different preferred color feeling.

Up to now, a lot of research activities have been performed for estimation of an illumination color in an image. Among representative ones, there are U.S. Pat. No. 4,685,071, U.S. Pat. No. 5,495,428, International Journal on Computer Vision Vol. 4, No. 1, pp 7˜38, 1990, and Korean Patent Publication Nos. 2000-38213 and 2001-46716. These patents and documents disclose methods of extracting the illumination color of an image by using highlight or similar information in the image, and the illumination color or color temperature obtained as the results is expressed by CIE XYZ color spaces or spectral curves of illumination.

The color temperature estimation unit 100 estimates the color temperature of the input image by using an arbitrary one of well-known methods including the methods described above, and preferably, the method of estimating an illumination color disclosed in the Korean Patent Publication Nos. 2000-38213 and 2001-46716 is incorporated as a reference in the present invention.

Backing to FIG. 1, the target color temperature calculation unit 110 receives the estimated color temperature of the input image and a user's preferred color temperature, and calculates a target color temperature adaptively varying based on the user's preferred color temperature according to the difference of the estimated color temperature and a predetermined reference color temperature. The target color temperature calculation unit 110 will be explained later in more detail.

The color temperature conversion unit 120 receives the input image and parameters required for color temperature conversion from the target color temperature calculation unit 110. By using the parameters, the color temperature conversion unit 120 converts the input image into an output image reflecting the user's preferred color temperature and transmits the output image to the image display system (not shown) to be displayed. Hereinafter, a method of converting a color temperature will be explained in more detail.

In order to convert a color temperature, an RGB signal is expressed in an XYZ space that is a standard color space, and for this the following processes need to be performed.

1) By using 3 primary colors and a color temperature of an input image, the RGB signal (RGBi) of the input image is converted into that in a CIE XYZ space:
3 primary colors: Red(Xr,Yr,Zr), Green(Xg,Yg,Zg), Blue(Xb,Yb,Zb)
Color temperature of an input image: Ws=(Xs,Ys,Zs)

2) Set a target color temperature desired in an output image in the CIE XYZ space: Wd=(Xd,Yd,Zd)

3) Obtain a color temperature conversion coefficient: Wc=Wd/Ws=(Xd/Xs,Yd/Ys,Zd/Zs)

4) Convert the RGB signal (RGBi) of the input image into the RGB signal (RGBo) of the output image in the CIE XYZ space by using the target color temperature of the output image and the 3 primary color values.

The color temperature conversion process described above can be expressed as Equation 2:

$$[ \begin{matrix}{R}_{0} \\ {G}_{0} \\ {B}_{0}\end{matrix} ] = [ \begin{matrix}c 11 & c 12 & c 13 \\ c 21 & c 22 & c 23 \\ c 31 & c 32 & c 33\end{matrix} ] [ \begin{matrix}Xd / Xs & 0 & 0 \\ 0 & Yd / Ys & 0 \\ 0 & 0 & Zd / Zs\end{matrix} ] [ \begin{matrix}b 11 & b 12 & b 13 \\ b 21 & b 22 & b 23 \\ b 31 & b 32 & b 33\end{matrix} ] [ \begin{matrix}{R}_{i} \\ {G}_{i} \\ {B}_{i}\end{matrix} ] \qquad ( 2 )$$

Here, matrix b is a 3×3 RGB-to-XYZ transform matrix formed with the 3 primary colors and the color temperature of the input image in the process ‘1)’, the diagonal matrix at the center is the color temperature conversion coefficient of the process ‘3)’, and matrix c is a 3×3 XYZ-to-RGB matrix formed with the target color temperature and the 3 primary colors of the process ‘4)’.

Equation 2 can be expressed as Equation 3:

$$[ \begin{matrix}{R}_{0} \\ {G}_{0} \\ {B}_{0}\end{matrix} ] = [ \begin{matrix}a 11 & a 12 & a 13 \\ a 21 & a 22 & a 23 \\ a 31 & a 32 & a 33\end{matrix} ] [ \begin{matrix}{R}_{i} \\ {G}_{i} \\ {B}_{i}\end{matrix} ] \qquad ( 3 )$$

When there is a request of a user's preferred color temperature, a color temperature of an input image is estimated, and when an estimated color temperature is simply converted into the user's preferred color temperature, input images having a variety of color temperatures are expressed as images having one color temperature as shown in FIG. 8. Accordingly, the respective characteristics of the images become to disappear. For example, both a red family color and a blue family color become an image having a single color temperature.

To solve this problem, in the present invention, a color temperature, for example, 6500K, which is generally used in a TV or a monitor is set as a reference color temperature, and the reference color temperature is set such that when there is a request of a user's preferred color temperature, the reference color temperature is converted into the user's preferred color temperature. Based on a mapping relation of the reference color temperature to the user's preferred color temperature, a color temperature of an input image is converted in an effective color temperature range.

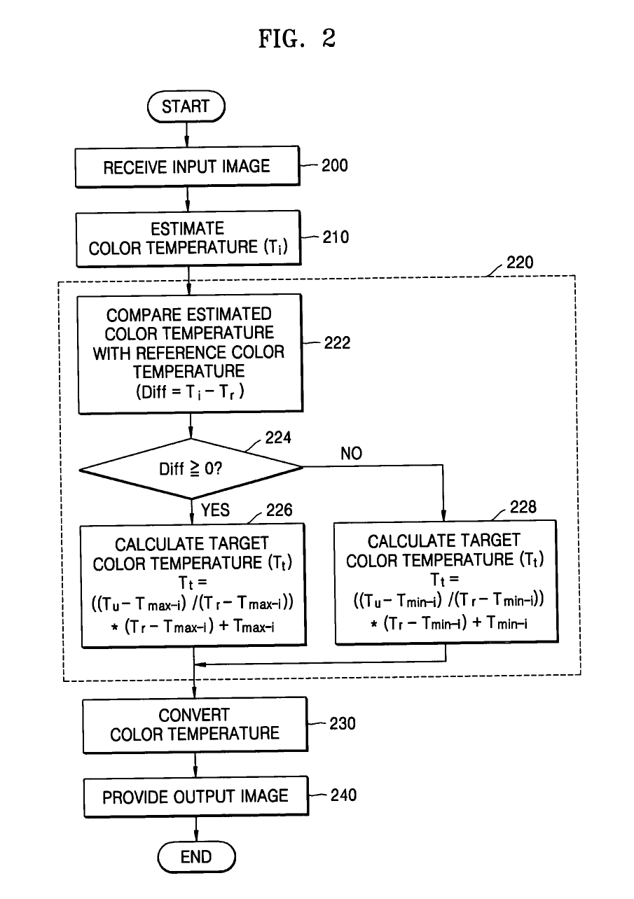

FIG. 2 is a flowchart explaining an adaptive image conversion method according to the present invention.

Referring to FIG. 2, the operation of the adaptive image conversion apparatus shown in FIG. 1, and the target color temperature calculation unit 110 in particular, will now be explained in more detail.

When there is a request of a user's preferred color temperature, a buffer memory (not shown) stores an effective color temperature range, a reference color temperature, and the user's preferred color temperature. Referring to FIG. 2, an input image is received in operation 200, and a color temperature (c_XT) of the input image is estimated in operation 210. According to the difference between the estimated color temperature and a preset reference color temperature, a target color temperature adaptively varying on the basis of the user's preferred color temperature is determined in operation 220.

FIG. 4 is a conceptual diagram explaining an embodiment of color temperature conversion forms according to the present invention.

Color temperatures of an input image and an output image are described as one point existing in an effective color temperature range (for example, 2000K˜14000K). If a reference color temperature (for example, 6500K) is set and a preferred color temperature (for example, 4500K) is determined by a user in an image display system, then, for each input image of the image display system, a target color temperature of an output image is determined according to the color temperature of the input image.

If there is an identical effective color temperature range for an input image and an output image, a calculation process for determining a target color temperature of the output image is as follows. Assuming that the minimum value of a color temperature of the input image is Tₘᵢₙ₋ᵢ, the maximum value of the color temperature of the input image is Tₘₐₓ₋ᵢ, the reference color temperature is Tᵣ, and the user's preferred color temperature is Tᵤ, a target color temperature of the output image Tₜ in relation to an arbitrary color temperature Tᵢ of the input image can be calculated by using Equation 4:

$$\begin{matrix}if ( {T}_{i} \geq {T}_{r} ) , {T}_{t} ≡ \frac{{T}_{max - i} - {T}_{u}}{{T}_{max - i} - {T}_{r}} \times ( {T}_{i} - {T}_{max - i} ) + {T}_{max - i} \\ if ( {T}_{i} < {T}_{r} ) , {T}_{t} ≡ \frac{{T}_{u} - {T}_{min - i}}{{T}_{r} - {T}_{min - i}} \times ( {T}_{i} - {T}_{min - i} ) + {T}_{min - i}\end{matrix} \qquad ( 4 )$$

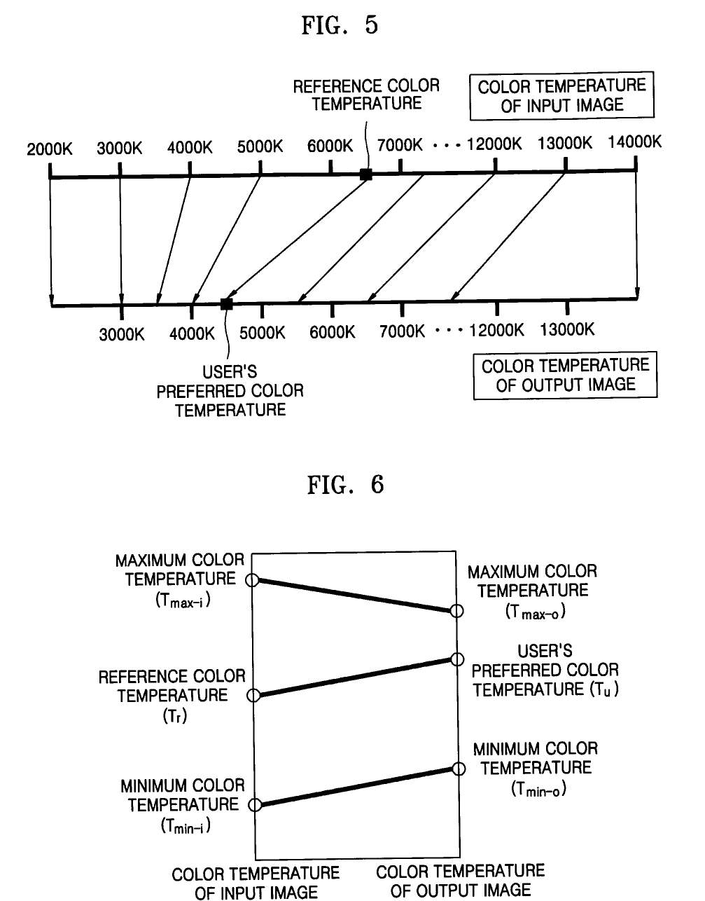

Equation 4 is a formula mapped to a linear conversion between the color temperature of the input image and the color temperature of the output image shown in FIG. 4. When an estimated color temperature of the input image is a maximum value or a minimum value of the color temperature of the input image, the estimated color temperature is kept without conversion. When an estimated color temperature is a value between the maximum and minimum values, the estimated color temperature has a characteristic that it is linearly converted toward the user's preferred color temperature. FIG. 5 is a graph showing this relation in more detail.

FIG. 6 is a conceptual diagram explaining another embodiment of color temperature conversion forms according to the present invention.

If the concentration degree of the target color temperature of the output image is desired to be raised based on the user's preferred color temperature, the input image and the output image have a separate effective color temperature range, respectively. Assuming that the minimum value of the color temperature of the input image is Tₘᵢₙ₋ᵢ, the maximum value of the color temperature of the input image is Tₘₐₓ₋ᵢ, the reference color temperature is Tᵣ, the user's preferred color temperature is Tᵤ, the minimum value of the color temperature of the output image is Tₘᵢₙ₋ₒ, and the maximum value of the color temperature of the output image is Tₘₐₓ₋ₒ, the target color temperature Tₜ of the output image in relation to an arbitrary color temperature Tᵢ of the input image can be calculated by using Equation 5:

$$\begin{matrix}if ( {T}_{i} \geq {T}_{r} ) , {T}_{t} ≡ \frac{{T}_{max - o} - {T}_{u}}{{T}_{max - i} - {T}_{r}} \times ( {T}_{i} - {T}_{max - i} ) + {T}_{max - o} \\ if ( {T}_{i} < {T}_{r} ) , {T}_{t} ≡ \frac{{T}_{u} - {T}_{min - o}}{{T}_{r} - {T}_{min - i}} \times ( {T}_{i} - {T}_{min - i} ) + {T}_{min - o}\end{matrix} \qquad ( 5 )$$

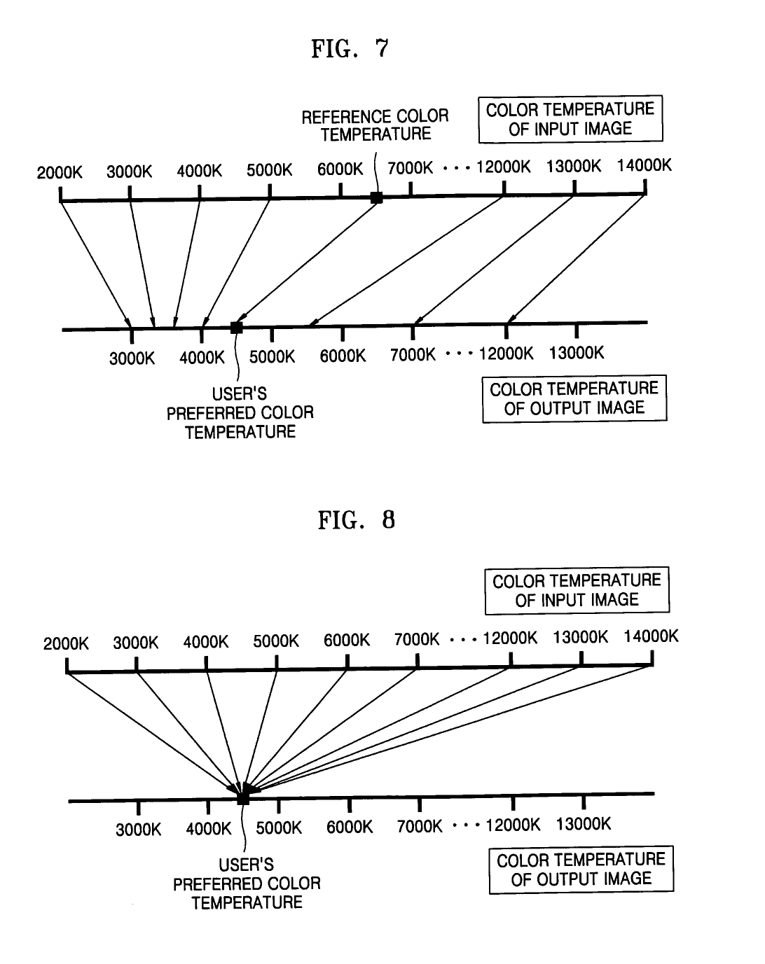

In Equation 5, by adjusting Tₘₐₓ₋ₒ and Tₘᵢₙ₋ₒ that define the effective color temperature range of the output image, the target color temperature of the output image in relation to the estimated color temperature of the input image can be linearly adjusted to more closely approach the user's preferred color temperature. Referring to FIG. 7, it is shown that the color temperature of the output image in relation to the color temperature of the input image converges more strongly on the user's preferred color temperature compared to that of FIG. 5.

Backing to FIG. 2, more specifically in the operation 220, by comparing the estimated color temperature of the input image and the reference color temperature, the difference is obtained in operation 222, and it is determined whether or not the difference is equal to or greater than 0 in operation 224. According to the determination result, that is, according to whether the difference is equal to or greater than 0 or the difference is less than 0, the target color temperature of the output image is calculated differently by using Equation 4 or 5 in operation 226 or 228.

Next, by using the target color temperature and the estimated color temperature obtained in the operation 210, a color temperature conversion coefficient is obtained and the input image is converted on the basis of the color temperature conversion coefficient to be generated as an output image in operation 230. For this operation, Equation 3 described above is applied such that the color temperature conversion of all pixels in the input image is performed.

Meanwhile, after the target color temperature (Tₜ) is calculated in the operation 220 described above, a final target color temperature (Tₜ′) which is nonlinearly converted by additionally applying a nonlinear function can be calculated. The target color temperature calculated by using Equation 4 or 5 for performing linear conversion can have a wide color temperature range. In order to strengthen the characteristic converging to the user's preferred color temperature in relation to an arbitrary color temperature of the input image, nonlinear methods can be applied. For example, a quadratic function or a gamma function can be applied to the result of Equation 4 or 5 as Equation 6:
Tₜ=scale×Tₙₒᵣ₋ₒ^{P}+offset (6)

Here, Tₙₒᵣ₋ₒ denotes the result of normalization of Tₜ, P denotes a multiplier, and scale and offset denote values for restoration to the original scale.

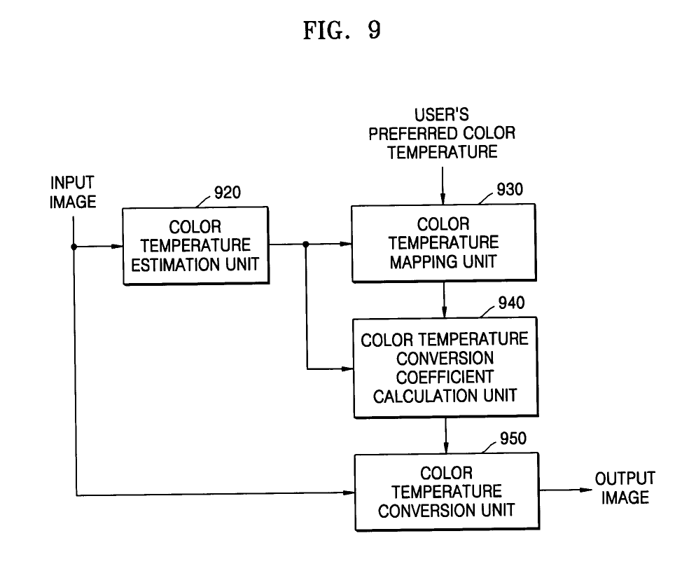

FIG. 9 is a block diagram of another embodiment of an adaptive image conversion apparatus according to the present invention. The adaptive image conversion apparatus includes a color temperature estimation unit 920, a color temperature mapping unit 930, a color temperature conversion coefficient calculation unit 940, and a color temperature conversion unit 950.

Referring to FIG. 9, an input image is provided to display on an image display system, such as a TV and a monitor. The input image is provided to the color temperature estimation unit 920 and the color temperature conversion unit 950.

The color temperature estimation unit 920 estimates the color temperature of an illuminant applied to the input image, and the estimated color temperature is provided to the color temperature mapping unit 930 and the color temperature conversion coefficient calculation unit 940.

The color temperature mapping unit 930 receives the estimated color temperature of the input image, and a user's preferred color temperature, and determines a target color temperature of an output image according to a preset color temperature mapping method. The determined target color temperature of the output image is provided to the color temperature conversion coefficient calculation unit 940.

The color temperature conversion coefficient calculation unit 940 calculates a color temperature conversion coefficient between the color temperature of the input image estimated in the color temperature estimation unit 920 and the target color temperature of the output image determined in the color temperature mapping unit 930, and the color temperature conversion coefficient is provided to the color temperature conversion unit 950.

The color temperature conversion unit 950 receives the input image 110 and the color temperature conversion coefficient, and performs color temperature conversion in relation to the input image to be provides as an output image.

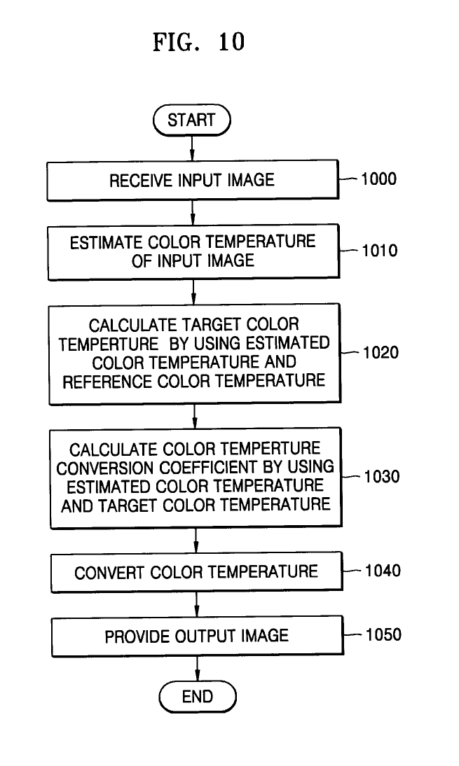

FIG. 10 is a flowchart showing an adaptive image conversion method applied to the adaptive image conversion apparatus of FIG. 9.

Referring to FIG. 10, an input image is received in operation 1000. The input image is received in units of frame in an image applied to a TV and the like. Then, the color temperature of the input image is estimated in operation 1010. Then, by using the estimated color temperature, a preset reference color temperature, and a user's preferred color temperature, the target color temperature of the output image is calculated in operation 1020. At this time, by mapping the reference color temperature to the user's preferred color temperature according to the method by which the estimated color temperature of the input image is mapped to the reference color temperature, the target color temperature of the output image is obtained.

The mapping method applied to the present embodiment will now be explained in more detail with reference to FIGS. 11 through 16. The method of mapping the color temperature in the present embodiment is designed so that the relative color temperature difference between continuous video frames can be maintained, and can be broken down into two types.

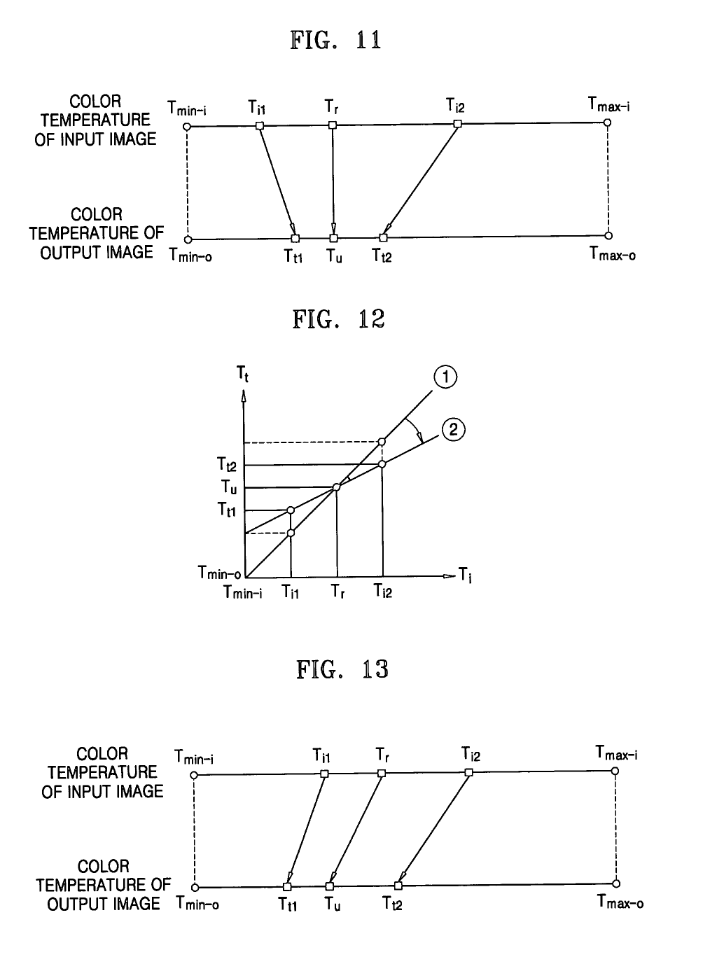

The first method is a mapping method providing a feeling of a predetermined color temperature. FIG. 11 illustrates a color temperature conversion form complying with this method, and to this form of color temperature conversion, the concept of the linear mapping shown in FIG. 12 and the concept of the nonlinear mapping shown in FIG. 15 can be applied.

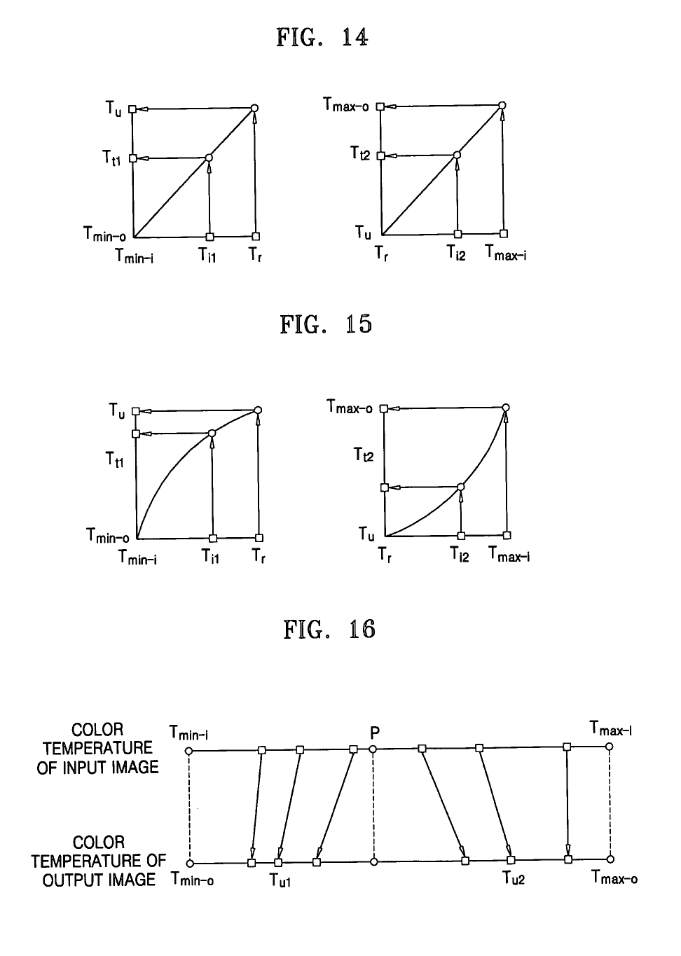

The second method is a method of mapping to a bluer or redder temperature than the conventional color temperature. FIG. 13 illustrates a color temperature conversion form complying with this method, and to this form of color temperature conversion, the concept of the linear mapping shown in FIG. 14 and the concept of the nonlinear mapping shown in FIG. 15 can be applied.

The process of color temperature mapping shown in FIG. 11 or 13 is as the following:

1) An estimated color temperature Tᵢ of an input image and a user's preferred color temperature Tᵤ are received.

2) A reference color temperature Tᵣ is preset.

The reference color temperature Tᵣ is set to be the same as the user's preferred color temperature (Tᵣ=Tᵤ) in the mapping method providing a feeling of a predetermined color temperature. In the method of mapping to a bluer or redder temperature than the reference color temperature, the reference color temperature Tᵣ is set to a predetermined value (for example, D65(=6500K)), or to be the same as an estimated color temperature of an input image displayed on an image display system when a user watching an image on the display system sets a reference color temperature.

3) A target color temperature Tₜ is obtained by mapping the reference color temperature Tᵣ to the user's preferred color temperature Tᵤ, and mapping the color temperature of the input image having values neighboring the reference color temperature according to the linear or nonlinear method.

When the color temperature of an input image, a user's preferred color temperature, and a reference color temperature are given, a process for determining a target color temperature of an output image can be expressed as follows. First, the linear mapping in a method of mapping to provide a feeling of a predetermined color temperature as in FIG. 11 can be expressed as Equation 7:

$${T}_{t} = \frac{{T}_{u}}{2 {T}_{r}} \times {T}_{i} + \frac{{T}_{u}}{2} \qquad ( 7 )$$

Here, Tᵢ denotes an estimated color temperature of an input image, Tᵤ denotes a color temperature that is input as a user's preferred color temperature, Tᵣ denotes a reference color temperature, and Tₜ denotes a target color temperature of an output image.

The concept of the idea according to Equation 7 is expressed in a graph of FIG. 12. In FIG. 12, straight line \textcircled{1} shows a case where color temperature conversion between an input image and an output image is not performed, and straight line \textcircled{2} shows a case where the straight line \textcircled{1} is rotated clockwise about the intersection of Tᵣ and T, to have a less slope such that a wide color temperature range of the input image is mapped to a narrow range centered at Tᵤ in the output image. That is, it can be seen that the color temperature range of the output image before the mapping of the color temperature range from Tᵢ₁ to Tᵢ₂ of a predetermined input image is the range between the intersections of the vertical axis and the dotted lines, but the color temperature range of the output image after the mapping according to the present invention is performed is narrowed to the range between the intersections of the vertical axis and the solid lines.

Next, the linear mapping in a method of mapping to a bluer or redder temperature than the reference color temperature in FIG. 13 can be expressed as Equation 8:

$$\begin{matrix}If {T}_{i} > {T}_{r} \\ {T}_{max - nor - i} = \frac{( {T}_{i} - {T}_{r} )}{( {T}_{max - i} - {T}_{r} )} , \\ {T}_{max - nor - i} = [ 0 , 1 ] \\ {f}_{1 st} ( {T}_{max - nor - i} ) = {T}_{max - nor - i} \\ {T}_{t} = ( {T}_{max - o} - {T}_{u} ) \times {f}_{1 st} ( {T}_{max - nor - i} ) + {T}_{u} , \\ if ( {T}_{i} \leq {T}_{r} \\ {T}_{min - nor - i} = \frac{( {T}_{i} - {T}_{min - i} )}{( {T}_{r} - {T}_{min - i} )} , \\ {T}_{min - nor - i} = [ 0 , 1 ] \\ {f}_{1 st} ( {T}_{min - nor - i} ) = {T}_{min - nor - i} \\ {T}_{t} = ( {T}_{u} - {T}_{min - o} ) \times {f}_{1 st} ( {T}_{min - nor - i} ) + {T}_{min - o}\end{matrix} \qquad ( 8 )$$

Here, Tᵢ denotes an estimated color temperature of an input image, Tᵤ denotes a color temperature that is input as a user's preferred color temperature, Tᵣ denotes a reference color temperature, Tₜ denotes a target color temperature of an output image, Tₙₒᵣ₋ₒ denotes a normalized value of the target color temperature in relation to the color temperature range of the output image, Tₘₐₓ₋ₙₒᵣ₋ᵢ denotes a normalized value of the color temperature range of the input image when Tᵢ>Tᵣ, Tₘₐₓ₋ₙₒᵣ₋ᵢ=[0,1] denotes that the value of Tₘₐₓ₋ₙₒᵣ₋ᵢ is a rational number greater than or equal to 0 and less than or equal to 1, Tₘᵢₙ₋ₙₒᵣ₋ᵢ denotes a normalized value of the color temperature range of the input image when Tᵢ≦Tᵣ, Tₘᵢₙ₋ₙₒᵣ₋ᵢ=[0,1] denotes that the value of Tₘᵢₙ₋ₙₒᵣ₋ᵢ is a rational number greater than or equal to 0 and less than or equal to 1, Tₘₐₓ₋ᵢ denotes the maximum value of the color temperature of the input image, Tₘᵢₙ₋ᵢ denotes the minimum value of the color temperature of the input image, Tₘₐₓ₋ₒ denotes the maximum value of the color temperature of the output image, and Tₘᵢₙ₋ₒ denotes the minimum value of the color temperature of the output image.

Next, mapping by a power function as shown in Equation 9 will now be explained as an example of the nonlinear mapping method as in FIG. 15. This nonlinear mapping method can be used to obtain the result shown in FIG. 11 or 13.

$$\begin{matrix}if {T}_{i} > {T}_{r} \\ {T}_{max - nor - i} = \frac{( {T}_{i} - {T}_{r} )}{( {T}_{max - i} - {T}_{r} )} , \\ {T}_{max - nor - i} = [ 0 , 1 ] \\ {f}_{pow} ( {T}_{max - nor - i} , α ) = {( {T}_{max - nor - i} )}^{α} \\ nor ( {f}_{pow} ( {T}_{max - nor - i} , α ) ) = \frac{\begin{matrix}( {f}_{pow} ( {T}_{max - nor - i} , α ) - \\ min [ {f}_{pow} ( {T}_{max - nor - i} , α ) ] )\end{matrix}}{\begin{matrix}( max [ {f}_{pow} ( {T}_{max - nor - i} , α ) ] - \\ min [ {f}_{pow} ( {T}_{max - nor - i} , α ) ] )\end{matrix}} \\ {T}_{t} = ( {T}_{max - o} {T}_{u} ) \times nor ( {f}_{pow} ( {T}_{max - nor - i} , α ) ) + {T}_{u} \\ else if ( {T}_{i} \leq {T}_{r} ) \\ {T}_{min - nor - i} = \frac{( {T}_{i} - {T}_{min - i} )}{( {T}_{r} - {T}_{min - i} )} , \\ {T}_{min - nor - i} = [ 0 , 1 ] \\ {f}_{pow} ( {T}_{min - nor - i} , α ) = {( {T}_{min - nor - i} )}^{\frac{1}{α}} \\ nor ( {f}_{pow} ( {T}_{min - nor - i} , α ) ) = \frac{\begin{matrix}( {f}_{pow} ( {T}_{min - nor - i} , α ) - \\ min [ {f}_{pow} ( {T}_{min - nor - i} , α ) ] )\end{matrix}}{\begin{matrix}( max [ {f}_{pow} ( {T}_{min - nor - i} , α ) ] - \\ min [ {f}_{pow} ( {T}_{min - nor - i} , α ) ] )\end{matrix}} \\ {T}_{t} = \begin{matrix}( {T}_{u} {T}_{min - o} ) \times \\ nor ( {f}_{pow} ( {T}_{min - nor - i} , α ) + {T}_{min - o}\end{matrix}\end{matrix} \qquad ( 9 )$$

Here, Tᵢ denotes an estimated color temperature of an input image, Tᵤ denotes a color temperature that is input as a user's preferred color temperature, Tᵣ denotes a reference color temperature, Tₜ denotes a target color temperature of an output image, Tₙₒᵣ₋ₒ denotes a normalized value of the target color temperature in relation to the color temperature range of the output image, Tₘₐₓ₋ₙₒᵣ₋ᵢ denotes a normalized value of the color temperature range of the input image when Tᵢ>Tᵣ, Tₘₐₓ₋ₙₒᵣ₋ᵢ=[0,1] denotes that the value of Tₘₐₓ₋ₙₒᵣ₋ᵢ is a rational number greater than or equal to 0 and less than or equal to 1, Tₘᵢₙ₋ₙₒᵣ₋ᵢ denotes a normalized value of the color temperature range of the input image when Tᵢ≦Tᵣ, Tₘᵢₙ₋ₙₒᵣ₋ᵢ=[0,1] denotes that the value of Tₘᵢₙ₋ₙₒᵣ₋ᵢ is a rational number greater than or equal to 0 and less than or equal to 1, Tₘₐₓ₋ᵢ denotes the maximum value of the color temperature of the input image, Tₘᵢₙ₋ᵢ denotes the minimum value of the color temperature of the input image, Tₘₐₓ₋ₒ denotes the maximum value of the color temperature of the output image, Tₘᵢₙ₋ₒ denotes the minimum value of the color temperature of the output image, and alpha (α) denotes the coefficient of the power function.

In Equation 9, alpha (α)≧1. If alpha (α)=1, a result identical to that of the linear mapping method can be obtained, and if alpha (α)=2, mapping by a quadratic equation can be obtained. The bigger the value of alpha (α) is, the bigger curvature the shape has.

In Equation 9, it is possible to perform mapping providing a feeling of a predetermined color temperature, by setting Tᵣ=Tᵤ, and it is also possible to perform mapping to a bluer or redder color temperature than the reference color temperature, by setting Tᵣ to an arbitrary value (for example, 6500K). FIG. 15 illustrates conceptually a power-function-type nonlinear mapping process that is expressed as Equation 9. In the present invention, in order to obtain a variety of mapping effects unless the function is beyond this concept, mapping by a variety of nonlinear functions, such as an exponential function, a logarithm function, a sigmoidal function, and a Gaussian function, can also be used.

If the concentration degree is desired to be heightened centered at the user's preferred color temperature regardless of whether a color temperature mapping method is linear or nonlinear, a desired result can be obtained by adjusting the minimum value and maximum value of the color temperature of the output image. In relation to this, FIG. 4 illustrates the concept.

In addition, there can be a method of converting a color temperature in which a color temperature range is divided into predetermined sections and the color temperature in each section is mapped differently as shown in FIG. 16.

Meanwhile, for the color temperature used when color temperature mapping is performed, absolute temperature K or reciprocal megakelvin (MK−1=106K−1) using a reciprocal scale such as 106/T can be used.

Referring FIG. 10 again, after the target color temperature of the output image is calculated as described above, the color temperature conversion coefficient is calculated by using the estimated color temperature of the input image and the target color temperature of the output image in operation 1030. This calculation of the color temperature conversion coefficient is performed in the color temperature conversion coefficient calculation unit 940. For example, assuming that Tᵢ denotes the estimated color temperature of the input image and Tₜ denotes the target color temperature, transform matrix Mc for conversion between color temperatures is calculated as the following process.

That is, in the process for obtaining the transform matrix Mc for conversion between color temperatures, first, each chromaticity value of the estimated color temperature of the input image and the target color temperature of the output image is calculated, and secondly, the chromaticity values are converted into XYZ tristimulus values respectively. Thirdly, by using the tristimulus values, a cone response of illumination corresponding to each of the input image and the output image is obtained and by using the cone responses, the transform matrix Mc is obtained.

The tristimulus values of the input image and the output image can be obtained by using Equations 10 and 11:

$$\begin{matrix}if ( 1667 K \leq T < 25000 K ) \\ x = - 0.2661239 \frac{{10}^{9}}{{T}^{3}} - 0.2343580 \frac{{10}^{6}}{{T}^{2}} + 0.8776956 \frac{{10}^{3}}{T} + 0.179910 \\ if ( 4000 K \leq T \leq 25000 K ) \\ x = - 3.0258469 \frac{{10}^{9}}{{T}^{3}} + 2.1070379 \frac{{10}^{6}}{{T}^{2}} + 0.2226347 \frac{{10}^{3}}{T} + 0.24039 \\ if x \leq 0.38405 , \\ y = 3.0817580 {x}^{3} - 5.8733867 {x}^{2} + 3.75112997 x - 0.37001483 \\ if 0.38405 < x \leq 0.50338 , \\ y = - 0.9549476 {x}^{3} - 1.37418593 {x}^{2} + 2.09137015 x - 0.16748867 \\ else , \\ y = - 1.1063814 {x}^{3} - 1.34811020 {x}^{2} + 2.18555832 x - 0.20219683\end{matrix} \qquad ( 10 )$$

X=(x/y)
Y=(y/y)
Z=(1−x−y)/y (11)

Here, T denotes the color temperature of an arbitrary image (input image or output image), and X, Y, and Z denote CIE XYZ tristimulus values of the chromaticity in an arbitrary image (input image or output image).

Assuming that the tristimulus values calculated in relation to the estimated color temperature Tᵢ of the input image and the target color temperature Tₜ of the output image are (X_{iw},Y_{iw},Z_{iw}) and (X_{tw},Y_{tw},Z_{tw}), respectively, the conversion relation between the tristimulus values of the input image and the tristimulus values of the output image can be expressed as Equation 12:

$$\begin{matrix}[ \begin{matrix}{X}_{tw} \\ {Y}_{tw} \\ {Z}_{tw}\end{matrix} ] = {[ \begin{matrix} \\ {M}_{BFD} \\ \end{matrix} ]}^{- 1} [ \begin{matrix} \\ D \\ \end{matrix} ] [ \begin{matrix} \\ {M}_{BFD} \\ \end{matrix} ] [ \begin{matrix}{X}_{tw} \\ {Y}_{tw} \\ {Z}_{tw}\end{matrix} ] \\ where , \\ [ \begin{matrix} \\ {M}_{BFD} \\ \end{matrix} ] = [ \begin{matrix}0.8951 & 0.2664 & - 0.1614 \\ - 0.7502 & 1.7135 & 0.0367 \\ 0.0389 & - 0.0685 & 1.0296\end{matrix} ] \\ {[ \begin{matrix} \\ {M}_{BFD} \\ \end{matrix} ]}^{- 1} = [ \begin{matrix}0.9870 & - 0.1471 & 0.1600 \\ 0.4323 & 0.5184 & 0.0493 \\ - 0.0085 & 0.0400 & 0.9685\end{matrix} ] \\ [ \begin{matrix} \\ D \\ \end{matrix} ] = [ \begin{matrix}{R}_{tw} / {R}_{iw} & 0 & 0 \\ 0 & {G}_{tw} / {G}_{iw} & 0 \\ 0 & 0 & {B}_{tw} / {B}_{iw}\end{matrix} ]\end{matrix} \qquad ( 12 )$$

Here, X_{iw}, Y_{iw}, and Z_{iw} denote the CIE XYZ tristimulus values calculated in relation to the estimated color temperature Tᵢ of the input image and X_{tw}, Y_{tw}, and Z_{tw} denote the CIE XYZ tristimulus values calculated in relation to the target color temperature Tₜ of the output image. Also, R_{iw}, G_{iw}, and B_{iw} denote the cone response of a corresponding illuminant in the input image, and R_{tw}, G_{tw}, and B_{tw} denote the cone response of a corresponding illuminant in the output image. These cone responses can be obtained by Equation 13:

$$[ \begin{matrix}{R}_{w} \\ {G}_{w} \\ {B}_{w}\end{matrix} ] = [ \begin{matrix} \\ {M}_{BFD} \\ \end{matrix} ] [ \begin{matrix}{X}_{w} / {Y}_{w} \\ {Y}_{w} / {Y}_{w} \\ {Z}_{w} / {Y}_{w}\end{matrix} ] \qquad ( 13 )$$

Here, R_{w}, G_{w}, and B_{w} denote the cone response of a corresponding illuminant in an arbitrary image, and X_{w}, Y_{w}, and Z_{w} denote CIE XYZ tristimulus values calculated in relation to the color temperature T of the arbitrary image.

Then, the transform matrix Mc for conversion between color temperatures can be obtained finally according to Equation 14:
[M_{c}]=[M_{BFD]}⁻¹[D][M_{BFD]} (14)

After the color temperature conversion coefficient is calculated through the above process, the color temperature of the input image is converted by using the color temperature conversion coefficient in operation 1040, and the image is provided as an output image in operation 1050.

The above color temperature conversion operation 1040 is performed, by using Equations 15 through 20. First, the RGB signal of the input image is converted into the CIE XYZ color space values, and by applying in the XYZ color space the conversion coefficient between color temperatures, the image is converted into the target color temperature of the output image. Then, by converting the converted XYZ into RGB, the output image is obtained.

Assuming that the color values of each pixel of the input image are (Rᵢ,Gᵢ,Bᵢ) and are in a linear conversion relation with CIE XYZ color space values, the color space values (Xᵢ,Yᵢ,Zᵢ) in relation to the input image can be determined as Equation 15:

$$[ \begin{matrix}{X}_{i} \\ {Y}_{i} \\ {Z}_{i}\end{matrix} ] = [ \begin{matrix}b 11 & b 12 & b 13 \\ b 21 & b 22 & b 23 \\ b 31 & b 32 & b 33\end{matrix} ] [ \begin{matrix}{R}_{i} \\ {G}_{i} \\ {B}_{i}\end{matrix} ] \qquad ( 15 )$$

Also, assuming that the color values of each pixel of the output image are (Rₒ,Gₒ,Bₒ) and are in a linear conversion relation with CIE XYZ color space values, the color value of each pixel in the output image can be determined from the color space values (Xₒ,Yₒ,Zₒ) in relation to the output image can be determined as Equation 16:

$$[ \begin{matrix}{R}_{o} \\ {G}_{o} \\ {B}_{o}\end{matrix} ] = [ \begin{matrix}c 11 & c 12 & c 13 \\ c 21 & c 22 & c 23 \\ c 31 & c 32 & c 33\end{matrix} ] [ \begin{matrix}{X}_{o} \\ {Y}_{o} \\ {Z}_{o}\end{matrix} ] \qquad ( 16 )$$

Conversion between color temperatures (Xᵢ,Yᵢ,Zᵢ) and (Xₒ,Yₒ,Zₒ) is determined as Equation 17:

$$[ \begin{matrix}{X}_{o} \\ {Y}_{o} \\ {Z}_{o}\end{matrix} ] = [ {M}_{c} ] [ \begin{matrix}{X}_{i} \\ {Y}_{i} \\ {Z}_{i}\end{matrix} ] \qquad ( 17 )$$

The color conversion process through the processes described above can be expressed in a single expression as Equation 18:

$$[ \begin{matrix}{R}_{o} \\ {G}_{o} \\ {B}_{o}\end{matrix} ] = [ \begin{matrix}c 11 & c 12 & c 13 \\ c 21 & c 22 & c 23 \\ c 31 & c 32 & c 33\end{matrix} ] [ {M}_{c} ] [ \begin{matrix}b 11 & b 12 & b 13 \\ b 21 & b 22 & b 23 \\ b 31 & b 32 & b 33\end{matrix} ] [ \begin{matrix}{R}_{i} \\ {G}_{i} \\ {B}_{i}\end{matrix} ] \qquad ( 18 )$$

In Equation 18, Mc has a 3×3 structure, and the entire conversion process can be expressed by one 3×3 matrix A as Equation 19:

$$\begin{matrix}[ A ] = [ \begin{matrix}a 11 & a 12 & a 13 \\ a 21 & a 22 & a 23 \\ a 31 & a 32 & a 33\end{matrix} ] \\ = [ \begin{matrix}c 11 & c 12 & c 13 \\ c 21 & c 22 & c 23 \\ c 31 & c 32 & c 33\end{matrix} ] [ {M}_{c} ] [ \begin{matrix}b 11 & b 12 & b 13 \\ b 21 & b 22 & b 23 \\ b 31 & b 32 & b 33\end{matrix} ]\end{matrix} \qquad ( 19 )$$

Accordingly, the color temperature conversion process of the image described above can be expressed as Equation 20:

$$[ \begin{matrix}{R}_{o} \\ {G}_{o} \\ {B}_{o}\end{matrix} ] = [ A ] [ \begin{matrix}{R}_{i} \\ {G}_{i} \\ {B}_{i}\end{matrix} ] \qquad ( 20 )$$

Here, Rᵢ, Gᵢ, and Bᵢ denote the color values of each pixel in the input image, Rₒ, Gₒ, and Bₒ denote the color values of each pixel in the output image, Xᵢ, Yᵢ, and Zᵢ denote the CIE XYZ color space values in relation to the input image, and Xₒ, Yₒ, Zₒ denote the CIE XYZ color space values in relation to the output image.

As described above, the color temperature conversion operation 1040 is a process converting the image so that the estimated color temperature of the input image can have the target color temperature of the output image. Though the color temperature conversion is performed after performing the processes expressed in Equations 15 through 20 in the present embodiment, the color temperature conversion operation 1040 can also be made to be performed such that the processes to the process for obtaining the matrix A are performed in the operation 1030 and only the process expressed by Equation 20 is performed in the present operation.

The above-described embodiments of the present invention can also be embodied as computer-readable codes stored on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and carrier waves (such as data transmission through the Internet). The computer-readable recording medium can also be distributed over network of coupled computer systems so that the computer readable code is stored and executed in a decentralized fashion.

According to the present invention as described above, when there is a request of a user's or a viewer's preferred color temperature in an image display system, input images having different color temperatures are smoothly converted into output images reflecting the user's preferred color temperature while maintaining the color characteristics between images. For this, the present invention uses multiple color temperature mapping methods with respect to the color temperature of the input image such that the user's preferred color temperature can be satisfied and at the same time the characteristics between images having difference color temperatures can be maintained.

Also, in the present invention, for conversion into user's preferred color temperature, the color temperature of an input image is estimated, and the method of converting into a bluer or redder color temperature than a reference color temperature, or the method of converting the color temperature of the input image to provide a feeling of a predetermined color temperature is used. By doing so, when continuous images having different color temperatures are displayed on an image display system, the user does not need to set frequently the preferred color temperature, and the color of the illuminant applied to the image is automatically converted while the relative color temperature difference characteristics among images are maintained.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An image conversion apparatus for adaptively converting an input image into an output image reflecting a user's preferred color comprising:
a color temperature estimation unit estimating a color temperature of the input image;
a target color temperature calculation unit receiving the estimated color temperature and the user's preferred color temperature, and obtaining a target color temperature adaptively varying on the basis of the user's preferred color temperature according to the difference of the estimated color temperature and a preset reference color temperature; and
a color temperature conversion unit obtaining a color temperature conversion coefficient from the estimated color temperature and the target color temperature and converting the input image into the output image based on the color temperature conversion coefficient.

2. The apparatus of claim 1, wherein the target color temperature calculation unit presets an identical effective color temperature range for the input image and the output image, and converts the estimated color temperature linearly so that in the effective color temperature range, the target color temperature is obtained based on a mapping relation of the reference color temperature to the user's preferred color temperature.

3. The apparatus of claim 1, wherein the target color temperature calculation unit presets a different effective color temperature range for the input image and the output image, respectively, and converts the estimated color temperature linearly so that in the effective color temperature range, the target color temperature is obtained based on a mapping relation of the reference color temperature to the user's preferred color temperature.

4. The apparatus of claim 2, wherein in the target color temperature calculation unit, the estimated color temperature is linearly converted toward the user's preferred color temperature.

5. The apparatus of claim 3, wherein in the target color temperature calculation unit, the estimated color temperature is linearly converted toward the user's preferred color temperature.

6. The apparatus of claim 2, wherein in the target color temperature calculation unit, the target color temperature obtained by linearly converting the estimated color temperature is nonlinearly converted by applying a nonlinear function.

7. The apparatus of claim 3, wherein in the target color temperature calculation unit, the target color temperature obtained by linearly converting the estimated color temperature is nonlinearly converted by applying a nonlinear function.

8. An image conversion method for adaptively converting an input image into an output image reflecting a user's preferred color comprising:
estimating a color temperature of the input image;
receiving the estimated color temperature and the user's preferred color temperature, and obtaining a target color temperature adaptively varying on the basis of the user's preferred color temperature according to the difference of the estimated color temperature and a preset reference color temperature; and
obtaining a color temperature conversion coefficient from the estimated color temperature and the target color temperature and converting the input image into the output image based on the color temperature conversion coefficient.

9. The method of claim 8, wherein in the calculating of the target color temperature, the target color temperature of the output image is calculated by using Equation:
$$\begin{matrix}if ( {T}_{i} \geq {T}_{r} ) , & {T}_{t} ≡ \frac{{T}_{max - i} - {T}_{u}}{{T}_{max - i} - {T}_{r}} \times ( {T}_{i} - {T}_{max - i} ) + {T}_{max - i} \\ if ( {T}_{i} < {T}_{r} ) , & {T}_{t} ≡ \frac{{T}_{u} - {T}_{min - i}}{{T}_{r} - {T}_{min - i}} \times ( {T}_{i} - {T}_{min - i} ) + {T}_{min - i}\end{matrix}$$
where Tᵢ denotes the estimated color temperature of the input image, Tᵣ denotes the reference color temperature, Tᵤ denotes the user's preferred color temperature, Tₜ is the target color temperature of the output image, Tₘᵢₙ₋ᵢ denotes the minimum value of a color temperature of the input image, and Tₘₐₓ₋ᵢ denotes the maximum value of the color temperature of the input image.

10. The method of claim 8, wherein in the calculating of the target color temperature, the target color temperature of the output image is calculated by using Equation:
$$\begin{matrix}if ( {T}_{i} \geq {T}_{r} ) , & {T}_{t} ≡ \frac{{T}_{max \text{-} o} - {T}_{u}}{{T}_{max \text{-} i} - {T}_{r}} \times ( {T}_{i} - {T}_{max \text{-} i} ) + {T}_{max \text{-} o} \\ if ( {T}_{i} < {T}_{r} ) , & {T}_{t} ≡ \frac{{T}_{u} - {T}_{min \text{-} o}}{{T}_{r} - {T}_{min \text{-} i}} \times ( {T}_{i} - {T}_{min \text{-} i} ) + {T}_{min \text{-} o}\end{matrix}$$
where Tᵢ denotes the estimated color temperature of the input image, Tᵣ denotes the reference color temperature, Tᵤ denotes the user's preferred color temperature, Tₜ is the target color temperature of the output image, Tₘᵢₙ₋ᵢ denotes the minimum value of a color temperature of the input image, Tₘₐₓ₋ᵢ denotes the maximum value of the color temperature of the input image, Tₘᵢₙ₋ᵢ denotes the minimum value of a color temperature of the output image, and Tₘₐₓ₋ₒ denotes the maximum value of the color temperature of the output image.

11. The method of claim 8, wherein in the calculating of the target color temperature, a final target color temperature is obtained by applying a nonlinear function to the calculated target color temperature.

12. A computer readable recording medium having embodied thereon a computer program for executing the method of claim 8.

13. An image conversion apparatus for adaptively converting an input image into an output image reflecting a user's preferred color comprising:
a color temperature estimation unit estimating a color temperature of the input image;
a color temperature mapping unit receiving the estimated color temperature and the user's preferred color temperature, and obtaining a target color temperature of the output image mapped by the estimated color temperature of the input image when a preset reference color temperature is mapped to the user's preferred color temperature;
a color temperature conversion coefficient calculation unit obtaining a color temperature conversion coefficient by using the estimated color temperature and the target color temperature; and
a color temperature conversion unit converting the input image into the output image based on the color temperature conversion coefficient.

14. The apparatus of claim 13, wherein the color temperature mapping unit sets the reference color temperature identical to the color temperature of the input image estimated at the instant the reference color temperature is set or the user's preferred color temperature is set.

15. The apparatus of claim 13, wherein the color temperature mapping unit maps the estimated color temperature of the input image to the target color temperature of the output image so that the output image provides a feeling of a predetermined color temperature.

16. The apparatus of claim 13, wherein the color temperature mapping unit maps the estimated color temperature of the input image to the target color temperature of the output image so that the output image has a redder or bluer color temperature than the reference color temperature.

17. The apparatus of claim 13, wherein the color temperature mapping unit performs linear conversion when mapping the estimated color temperature of the input image to the target color temperature of the output image.

18. The apparatus of claim 13, wherein the color temperature mapping unit performs nonlinear conversion when mapping the estimated color temperature of the input image to the target color temperature of the output image.

19. The apparatus of claim 13, wherein the color temperature mapping unit divides a color temperature range of the input image into predetermined sections, and presets a reference color temperature value, a user's preferred color temperature value, and a mapping method for each of the section, and by applying the preset reference color temperature value, the user's preferred color temperature, and the mapping method to a section to which the estimated color temperature of the input image belongs, maps the estimated color temperature of the input image to the target color temperature of the output image.

20. An image conversion method for adaptively converting an input image into an output image reflecting a user's preferred color comprising:
estimating a color temperature of the input image;
receiving the estimated color temperature and the user's preferred color temperature, and obtaining a target color temperature of the output image mapped by the estimated color temperature of the input image when a preset reference color temperature is mapped to the user's preferred color temperature;
obtaining a color temperature conversion coefficient by using the estimated color temperature and the target color temperature; and
converting the input image into the output image based on the color temperature conversion coefficient.

21. The method of claim 20, wherein in the receiving of the estimated input color temperature and the user's preferred color temperature and the obtaining of the target color temperature further comprises:
setting the reference color temperature identical to the color temperature of the input image estimated at the instant the reference color temperature is set or the user's preferred color temperature is set.

22. The method of claim 20, wherein in the receiving of the estimated input color temperature and the user's preferred color temperature and the obtaining of the target color temperature, the estimated color temperature of the input image is mapped to the target color temperature of the output image so that the output image provides a feeling of a predetermined color temperature.

23. The method of claim 20, wherein in the receiving of the estimated input color temperature and the user's preferred color temperature and the obtaining of the target color temperature, the target color temperature is determined to be in proportion to a value obtained by dividing the estimated color temperature and the user's preferred color temperature by the reference color temperature value.

24. The method of claim 20, wherein in the receiving of the estimated input color temperature and the user's preferred color temperature and the obtaining of the target color temperature, the estimated color temperature of the input image is mapped to the target color temperature of the output image so that the output image has a redder or bluer color temperature than the reference color temperature.

25. The method of claim 24, wherein in the receiving of the estimated input color temperature and the user's preferred color temperature and the obtaining of the target color temperature, if the estimated color temperature is greater than the reference color temperature, the target color temperature is determined to be in proportion to a value obtained by dividing a value obtained by subtracting the reference color temperature from the estimated color temperature, by a value obtained by subtracting the reference color temperature from the maximum value of the color temperature of the input image, and if the estimated color temperature is less than or equal to the reference color temperature, the target color temperature is determined to be in proportion to a value obtained by dividing a value obtained by subtracting the minimum value of the color temperature of the input image from the estimated color temperature, by a value obtained by subtracting the minimum value of the color temperature of the input image from the reference color temperature.

26. The method of claim 24, wherein in the receiving of the estimated input color temperature and the user's preferred color temperature and the obtaining of the target color temperature, the target color temperature of the output image is calculated by using Equation:
$$If {T}_{i} > {T}_{r}$$
$${T}_{max \text{-} nor \text{-} i} = \frac{( {T}_{i} - {T}_{r} )}{( {T}_{max \text{-} i} - {T}_{r} )} , {T}_{max \text{-} nor \text{-} i} = [ 0 , 1 ]$$
$${f}_{1 st} ( {T}_{max \text{-} nor \text{-} i} ) = {T}_{max \text{-} nor \text{-} i}$$
$${T}_{t} = ( {T}_{max \text{-} o} - {T}_{u} ) \times {f}_{1 st} ( {T}_{max \text{-} nor \text{-} i} ) + {T}_{u} , \\ if {T}_{i} \leq {T}_{r}$$
$${T}_{min \text{-} nor \text{-} i} = \frac{( {T}_{i} - {T}_{min \text{-} i} )}{( {T}_{r} - {T}_{min \text{-} i} )} , {T}_{min \text{-} nor \text{-} i} = [ 0 , 1 ] \\ {f}_{1 st} ( {T}_{min \text{-} nor \text{-} i} ) = {T}_{min \text{-} nor \text{-} i} \\ {T}_{t} = ( {T}_{u} - {T}_{min \text{-} o} ) \times {f}_{1 st} ( {T}_{min \text{-} nor \text{-} i} ) + {T}_{min \text{-} o}$$
where Tᵢ denotes the estimated color temperature of the input image, Tᵤ denotes the user's preferred color temperature, Tᵣ denotes the reference color temperature, Tₜ denotes the target color temperature of an output image, Tₙₒᵣ₋ₒ denotes a normalized value of the target color temperature in relation to the color temperature range of the output image, Tₘₐₓ₋ₙₒᵣ₋ᵢ denotes a normalized value of the color temperature range of the input image when Tᵢ>Tᵣ, Tₘₐₓ₋ₙₒᵣ₋ᵢ=[0,1] denotes that the value of Tₘₐₓ₋ₙₒᵣ₋ᵢ is a rational number greater than or equal to 0 and less than or equal to 1, Tₘᵢₙ₋ₙₒᵣ₋ᵢ denotes a normalized value of the color temperature range of the input image when Tᵢ≦Tᵣ, Tₘᵢₙ₋ₙₒᵣ₋ᵢ=[0,1] denotes that the value of Tₘᵢₙ₋ₙₒᵣ₋ᵢ is a rational number greater than or equal to 0 and less than or equal to 1, Tₘₐₓ₋ᵢ denotes the maximum value of the color temperature of the input image, Tₘᵢₙ₋ᵢ denotes the minimum value of the color temperature of the input image, Tₘₐₓ₋ₒ denotes the maximum value of the color temperature of the output image, and Tₘᵢₙ₋ₒ denotes the minimum value of the color temperature of the output image.

27. The method of claim 20, wherein in the receiving of the estimated input color temperature and the user's preferred color temperature and the obtaining of the target color temperature, nonlinear conversion is performed in order to map the estimated color temperature of the input image to the target color temperature of the output image.

28. The method of claim 27, wherein in the receiving of the estimated input color temperature and the user's preferred color temperature and the obtaining of the target color temperature, if the target color temperature is greater than the reference color temperature, the target color temperature is determined to be in proportion to a function value of nor(f_{pow}(Tₘₐₓ₋ₙₒᵣ₋ᵢ, α)) defined as:
$$if {T}_{max \text{-} nor \text{-} i} = \frac{( {T}_{i} - {T}_{r} )}{( {T}_{max \text{-} i} - {T}_{r} )} , \\ {T}_{max \text{-} nor \text{-} i} = [ 0 , 1 ]$$
$${f}_{pow} ( {T}_{max \text{-} nor \text{-} i} , α ) = {( {T}_{max \text{-} nor \text{-} i} )}^{α}$$
$$nor ( {f}_{pow} ( {T}_{max \text{-} nor \text{-} i} , α ) ) = \frac{( {f}_{pow} ( {T}_{max \text{-} nor \text{-} i} , α ) - min [ {f}_{pow} ( {T}_{max \text{-} nor \text{-} i} , α ) ] )}{( max [ {f}_{pow} ( {T}_{max \text{-} nor \text{-} i} , α ) ] - min [ {f}_{pow} ( {T}_{max \text{-} nor \text{-} i} , α ) ] )} ,$$
and if the target color temperature is less than or equal to the reference color temperature, the target color temperature is determined to be in proportion to a function value of nor(f_{pow}(Tₘₐₓ₋ₙₒᵣ₋ᵢ, α)) defined as:
$$if$$
$${T}_{min \text{-} nor \text{-} i} = \frac{( {T}_{i} - {T}_{min \text{-} i} )}{( {T}_{r} - {T}_{min \text{-} i} )} , {T}_{min \text{-} nor \text{-} i} = [ 0 , 1 ] \\ {f}_{pow} ( {T}_{min \text{-} nor \text{-} i} , α ) = {( {T}_{min \text{-} nor \text{-} i} )}^{\frac{1}{α}}$$
$$nor ( {f}_{pow} ( {T}_{min \text{-} nor \text{-} i} , α ) ) = \frac{( {f}_{pow} ( {T}_{min \text{-} nor \text{-} i} , α ) - min [ {f}_{pow} ( {T}_{min \text{-} nor \text{-} i} , α ) ] )}{( max [ {f}_{pow} ( {T}_{min \text{-} nor \text{-} i} , α ) ] - min [ {f}_{pow} ( {T}_{min \text{-} nor \text{-} i} , α ) ] )}$$
where Tᵢ denotes the estimated color temperature of the input image, Tᵤ denotes the user's preferred color temperature, Tᵣ denotes the reference color temperature, Tₜ denotes the target color temperature of the output image, Tₙₒᵣ₋ₒ denotes a normalized value of the target color temperature in relation to the color temperature range of the output image, Tₘₐₓ₋ₙₒᵣ₋ᵢ denotes a normalized value of the color temperature range of the input image when Tᵢ>Tᵣ, Tₘₐₓ₋ₙₒᵣ₋ᵢ=[0,1] denotes that the value of Tₘₐₓ₋ₙₒᵣ₋ᵢ is a rational number greater than or equal to 0 and less than or equal to 1, Tₘᵢₙ₋ₙₒᵣ₋ᵢ denotes a normalized value of the color temperature range of the input image when Tᵢ≦Tᵣ, Tₘᵢₙ₋ₙₒᵣ₋ᵢ=[0,1] denotes that the value of Tₘᵢₙ₋ₙₒᵣ₋ᵢ is a rational number greater than or equal to 0 and less than or equal to 1, Tₘₐₓ₋ᵢ denotes the maximum value of the color temperature of the input image, Tₘᵢₙ₋ᵢ denotes the minimum value of the color temperature of the input image, Tₘₐₓ₋ₒ denotes the maximum value of the color temperature of the output image, Tₘᵢₙ₋ₒ denotes the minimum value of the color temperature of the output image, and alpha (α) denotes the coefficient of the power function.

29. The method of claim 20, wherein in the receiving of the estimated input color temperature and the user's preferred color temperature and the obtaining of the target color temperature, a color temperature range of the input image is divided into predetermined sections, and a reference color temperature, a user's preferred color temperature, and a mapping method for each of the section are preset, and by applying the preset reference color temperature, the user's preferred color temperature, and the mapping method to a section to which the estimated color temperature of the input image belongs, the estimated color temperature of the input image is mapped to the target color temperature of the output image.

30. The method of claim 20, wherein the obtaining of the color temperature conversion coefficient comprises:
calculating the chromaticity value corresponding to the estimated color temperature of the input image and the chromaticity value of the target color temperature of the output image, and converting the chromaticity values to CIE XYZ tristimulus values; and
by using the tristimulus values, obtaining cone responses of the input image and the output image, respectively, and based on the cone responses, obtaining the color temperature conversion coefficient.

31. The method of claim 30, wherein in the converting of the chromaticity values, the chromaticity value is converted into CIE XYZ stimulus values based on values x, y and z defined as:
$$if ( 1667 K \leq T < 25000 K )$$
$$x = - 0.2661239 \frac{{10}^{9}}{{T}^{3}} - 0.2343580 \frac{{10}^{6}}{{T}^{2}} + 0.8776956 \frac{{10}^{3}}{T} + 0.179910$$
$$else if ( 4000 K \leq T \leq 25000 K )$$
$$x = - 3.0258469 \frac{{10}^{9}}{{T}^{3}} + 2.1070379 \frac{{10}^{6}}{{T}^{2}} + 0.2226347 \frac{{10}^{3}}{T} + 0.24039$$
if x≦0.38405,
y=3.0817580x³−5.8733867x²+3.75112997x−0.37001483
else if 0.38405<x≦50.50338,
y=−0.9549476x³−1.37418593x²+2.09137015x−0.16748867,
otherwise
y=−1.1063814x³−1.34811020x²+2.18555832x−0.20219683,
X=(x/y)
Y=(Y/Y)
Z=(1−x−y)/y

32. The method of claim 30, wherein in the obtaining of the color temperature conversion coefficient, the color conversion coefficient is determined based on a matrix value defined as:
$$[ {M}_{BFD} ] = [ \begin{matrix}0.8951 & 0.2664 & - 0.1614 \\ - 0.7502 & 1.7135 & 0.0367 \\ 0.0389 & - 0.0685 & 1.0296\end{matrix} ]$$

33. The method of claim 20, wherein in the converting of the input image into the output image, the RGB value of the input image is converted into CIE XYZ value, and by using the converted CIE XYZ values and the color temperature conversion coefficient, the CIE XYZ value of the target color temperature of the output image is obtained, and then the CIE XYZ value is converted again to an RGB value.

34. A computer readable recording medium having embodied thereon a computer program for executing the method of claim 20.
